(19) United States
(12) Patent Application Publication
(10) Pub. No.: US 2024/0327605 A1
(43) Pub. Date: Oct. 3, 2024

(54) COMPOSITION, MOLDED ARTICLE, FIXING MEMBER, FIXING DEVICE, AND IMAGE FORMING APPARATUS

(71) Applicant: FUJIFILM Business Innovation Corp., Tokyo (JP)

(72) Inventors: Ryohei YOSHIKAWA, Ebina-shi (JP); Kenji KAJIWARA, Ebina-shi (JP); Hiroaki TANAKA, Ebina-shi (JP); Taiki NAGAMATSU, Ebina-shi (JP); Tomotake INAGAKI, Ebina-shi (JP); Masayuki SEKO, Ebina-shi (JP)

(73) Assignee: FUJIFILM Business Innovation Corp., Tokyo (JP)

(21) Appl. No.: 18/455,977

(22) Filed: Aug. 25, 2023

(30) Foreign Application Priority Data
Mar. 28, 2023 (JP) 2023-051954

(51) Int. Cl. C08K 3/34; C08K 3/04; C08K 3/22; C08K 3/38; G03G 15/20

(52) U.S. Cl. CPC C08K 3/34; C08K 3/041; C08K 3/042; C08K 3/22; C08K 3/38; G03G 15/206; C08K 2003/2227; C08K 2003/385; C08K 2201/001; C08K 2201/005

(57) ABSTRACT

A composition contains at least one or more thermal conductive fillers and a resin or rubber, in which the fillers have a shape factor SF1 of 120 or more and 400 or less and a shape factor SF2 of 140 or more and 325 or less.

### CROSS-REFERENCE TO RELATED APPLICATIONS

This application is based on and claims priority under 35 USC 119 from Japanese Patent Application No. 2023-051954 filed Mar. 28, 2023.

### BACKGROUND

### (i) Technical Field

The present invention relates to a composition, a molded article, a fixing member, a fixing device, and an image forming apparatus.

### (ii) Related Art

JP2015-118327A discloses “a resin substrate containing a resin, a first filler that has an aspect ratio of 2 or more and is dispersed in the resin in a state of being aligned in an in-plane direction of the substrate, and a second filler that has an aspect ratio of 2 or more and a major axis shorter than a major axis of the first filler and is dispersed in the resin in a state of being aligned in a thickness direction of the substrate”.

JP4911674B discloses “a seamless-type cylindrical heating and fixing member having an elastic layer, in which the elastic layer contains an elastic material, carbon fibers dispersed in the elastic material, and an alignment inhibiting component; the alignment of the carbon fibers in a plane direction of the elastic layer is inhibited by the alignment inhibiting component; the alignment inhibiting component is particles; in a case where R (μm) represents a weight-average particle size of the particles, the weight-average particle size R (μm) and an average fiber diameter D (μm) of the carbon fibers satisfies a relationship of 0.5≤R/D≤10; and a thermal conductivity of the elastic layer in a thickness direction is 1.0 W/(m·K) or more”.

### SUMMARY

For the molded article of the related art that needs to have a high conductivity, such as a fixing member, improving the thermal conductivity is one of the challenges, and further improvement of the thermal conductivity is being required. Aspects of non-limiting embodiments of the present disclosure relate to a composition that contains at least one or more thermal conductive fillers and a resin or rubber and has a higher thermal conductivity compared to a composition in which a shape factor SF1 of the filler is less than 120 or more than 400 or a shape factor SF2 of the filler is less than 140 or more than 325.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above object include the following aspects.

According to an aspect of the present disclosure, there is provided a composition containing at least one or more thermal conductive fillers and a resin or rubber,
in which the fillers have a shape factor SF1 of 120 or more and 400 or less and a shape factor SF2 of 140 or more and 325 or less.

### BRIEF DESCRIPTION OF THE DRAWINGS

Exemplary embodiment(s) of the present invention will be described in detail based on the following figures, wherein:

FIG. 1 is a schematic cross-sectional view showing an example of a fixing member according to the present exemplary embodiment;

FIG. 2 is a schematic configuration view showing an example of a fixing device according to a first exemplary embodiment;

FIG. 3 is a schematic configuration view showing an example of a fixing device according to a second exemplary embodiment; and

FIG. 4 is a schematic configuration view showing an example of an image forming apparatus according to the present exemplary embodiment.

### DETAILED DESCRIPTION

The exemplary embodiments as an example of the present invention will be described below. The following descriptions and examples merely illustrate the present invention, and do not limit the present invention.

Regarding the ranges of numerical values described in stages in the present specification, the upper limit or lower limit of a range of numerical values may be replaced with the upper limit or lower limit of another range of numerical values described in stages. Furthermore, in the present specification, the upper limit or lower limit of a range of numerical values may be replaced with values described in examples.

In the present specification, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members. Furthermore, in some cases, the members having substantially the same function are marked with the same reference numeral throughout the all drawings such that the members will not be redundantly described as appropriate.

In the present specification, each component may include two or more kinds of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

The exemplary embodiments as an example of the present invention will be described below.

### Composition

The composition according to the present exemplary embodiment is a composition containing at least one or more thermal conductive fillers and a resin or rubber, in which the fillers have a shape factor SF1 of 120 or more and 400 or less and a shape factor SF2 of 140 or more and 325 or less.

In the related art, from the viewpoint of increasing the thermal conductivity of a resin molded article and a rubber molded article, a composition containing a thermal conductive filler has been developed. In the related art, in order to obtain the desired thermal conductivity from a composition containing rubber or a resin and a thermal conductive filler, elaborate control of alignment properties of the filler by using a device or the like, such as aligning a needle-shaped or rod-shaped filler (hereinafter, also called “alignable filler”) in the direction of heat conduction, is necessary, which has been a factor that makes it difficult to implement such control in some cases and increase costs.

On the other hand, having the above configuration, the composition according to the present exemplary embodiment has excellent thermal conductivity when made into a molded article. The mechanism of action thereof is unclear, but is assumed to be as follows.

The shape factor SF1 represents a degree of roundness of a filler, in other words, a degree of irregularity. The larger the numerical value of the shape factor SF1, the more irregular the filler is. The shape factor SF2 represents a degree of surface roughness of a filler. The larger the numerical value of the shape factor SF2, the rougher the surface of the filler is.

The composition according to the present exemplary embodiment contains a thermal conductive filler that has a shape factor SF1 of 120 or more and 400 or less and a shape factor SF2 of 140 or more and 325 or less.

In a case where the value of the shape factor SF1 of the filler is 120 or more, the shape of the filler is not too close to a needle shape. In a case where the value of the shape factor SF1 of the filler is 400 or less, the shape of the filler is not too close to a spherical shape. That is, the filler has an appropriate irregular shape, which makes it difficult for the filler to have alignment properties in a molded article when the composition is made into the molded article.

In a case where the value of the shape factor SF2 of the filler is 140 or more, the surface roughness of the filler is not too high. In a case where the value of the shape factor SF2 of the filler is 325 or less, the surface roughness of the filler is not too low. That is, the filler has an appropriate surface roughness, which increases the contact area between the fillers in a molded article when the composition is made into the molded article. As a result, when the composition is made into a molded article, excellent thermal conductivity is obtained.

Furthermore, in the composition according to the present disclosure, the filler has a larger contact area as appropriate and is more unlikely to be aligned in the molded article, as compared with the alignable filler of the related art having a shape factor SF1 and a shape factor SF2 that do not satisfy the above ranges. Therefore, excellent bending resistance is exhibited in a plane direction (that is, a plane on the side facing the alignment direction) as well.

### Characteristics of Composition

The thermal conductivity of the composition according to the present exemplary embodiment is, for example, preferably 1.2 W/mK or more, more preferably 1.3 W/mK or more, and even more preferably 1.5 W/mK or more.

In a case where the thermal conductivity of the composition is 1.2 W/mK or more, a higher thermal conductivity, such as heat dissipation properties, is obtained when the composition is made into a molded article containing the composition.

A specific method of making the thermal conductivity of the composition fall into the above range is not particularly limited. For example, it is possible to control the thermal conductivity by adjusting the shape factors SF1 and SF2 of the thermal conductive filler contained in the composition, adjusting the material of the filler, and the like.

The thermal conductivity is measured under the condition of a load of 50 g by a temperature wave analysis method using ai-phase (manufactured by Ai-Phase Co., Ltd.)

### Filler

The filler is a thermal conductive filler and has a shape factor SF1 of 120 or more and 400 or less, and a shape factor SF2 of 140 or more and 325 or less.

“Thermal conductive” means that the thermal conductivity is 0.5 W/(mK) or more.

Examples of the filler include carbon black such as Ketjen black, acetylene black, or graphite, fibrous carbon such as carbon nanotubes; silicon carbide (SiC), silicon nitride (Si₃N₄), boron nitride (BN), aluminum nitride, aluminum oxide, and the like. One filler may be used alone, or two or more fillers may be used in combination.

The shape factor SF1 of the filler is 120 or more and 400 or less. The shape factor SF1 is, for example, preferably 125 or more and 380 or less, more preferably 125 or more and 300 or less, and even more preferably 130 or more and 200 or less.

In a case where the value of the shape factor SF1 of the filler is 120 or more, the shape of the filler is not too close to a needle shape. In a case where the value of the shape factor SF1 of the filler is 400 or less, the shape of the filler is not too close to a spherical shape. That is, the filler has an appropriate irregular shape. Accordingly, when the composition is made into a molded article, the filler does not have alignment properties in the molded article.

The shape factor SF2 of the filler is 140 or more and 325 or less. The shape factor SF2 is, for example, preferably 150 or more and 300 or less, more preferably 155 or more and 300 or less, and even more preferably 160 or more and 298 or less.

In a case where the value of the shape factor SF2 of the filler is 140 or more, the surface roughness of the filler is not too high. In a case where the value of the shape factor SF2 of the filler is 325 or less, the surface roughness of the filler is not too low. That is, the filler has an appropriate surface roughness. Accordingly, when the composition is made into a molded article, the contact area where the fillers are entangled with each other in the molded article increases. As a result, when the composition is made into a molded article, excellent thermal conductivity is obtained.

The shape factor SF1 is quantified generally by analyzing a micrograph or an image of a scanning electron microscope (SEM) by performing binarization processing (that is, Otsu's binarization) with image processing software Image J, and is calculated as follows. For a test piece obtained from the molded article of the composition, 100 random primary particles of the filler are observed with SEM, the maximum lengths and projected areas thereof are determined to calculate SF1 by the following equation, and the arithmetic mean thereof is calculated to obtain the shape factor SF1.

$$SF 1 = ( ML 2 / A ) \times ( π / 4 ) \times 100 \qquad Equation$$

In the above equation, ML is the maximum length of the filler, and A is the projected area of the filler. The maximum length refers to the Feret diameter (major axis by elliptic approximation).

The shape factor SF2 is quantified by analyzing an SEM image by binarization processing (that is, Otsu's binarization) with image processing software Image J, and is calculated as follows. For a test piece obtained from the molded article of the composition, 100 random primary particles of the filler are observed with SEM, the perimeters and projected areas thereof are determined to calculate SF2 by the following equation, and the arithmetic mean thereof is adopted as the shape factor SF2.

$$SF 2 = \{ PM 2 / ( 4 π A ) \} \times 100 \qquad Equation$$

In the above equation, PM is the outer perimeter of the filler, and A is the projected area of the filler.

Specific methods of making the shape factors SF1 and SF2 of the filler fall into the above ranges are not particularly limited. Examples thereof include methods such as adjusting the aspect ratio of the filler and adjusting the material of the filler, and the like.

The shape of the filler may be any of an irregular shape, a scaly shape, a rod shape, a spherical shape, a fibrous shape, and the like, as long as the shape factor SF1 and the shape factor SF2 satisfy the above ranges.

In a case where the composition contains a resin, a number-average particle size of the filler is, for example, preferably 0.5 μm or more and 10.0 μm or less, more preferably 1.0 μm or more and 8.0 μm or less, and even more preferably 1.5 μm or more and 5.0 μm or less.

In a case where the composition contains rubber, a number-average particle size of the filler is, for example, preferably 15.0 μm or more and 40.0 μm or less, more preferably 15.0 μm or more and 35.0 μm or less, and even more preferably 15.0 μm or more and 24.0 μm or less.

The number-average particle size of the filler is measured by observation with a scanning electron microscope (SEM).

The SEM observation is performed using an ultra-high resolution field emission scanning electron microscope (FE-SEM, S-4800 manufactured by Hitachi High-Tech Corporation.) at an acceleration voltage of 200 kV. During the observation, the acceleration voltage is set to 200 kV. In a case where SEM observation is to be performed, a small amount of ethanol is added to the sample, the sample is treated with ultrasonic waves (45 kHz, 30 minutes) to obtain a suspension, a trace of the suspension is added dropwise to a microgrid (Okenshoji Co., Ltd.: Cu150P grid, carbon reinforced, grid pitch 150 μm) and dried at 50° C. in a vacuum for 2 hours to obtain a sample for SEM observation. “Particle size” refers to the maximum distance among the distances between two points on the contour (that is, the outer edge) of the filler when the filler is observed. Five random points in a test piece obtained from the molded article of the composition is observed with SEM to measure secondary particles and primary particle sizes of the observed filler. Then, an arithmetic mean of the measured particle sizes is calculated and adopted as the number-average particle size.

Specific methods of making the number-average particle size of the filler fall into the above range are not particularly limited. Examples thereof include methods such as adjusting the aspect ratio of the filler and adjusting the material of the filler, and the like.

The content of the filler is, for example, preferably 5% by volume or more and 50% by volume or less with respect to the composition.

In a case where the molded article of the composition according to the present exemplary embodiment is to be used for a fixing member, from the viewpoint of a higher thermal conductivity and ensuring strength, the content of the filler with respect to the composition is, for example, more preferably 5% by volume or more and 20% by volume or less, and even more preferably 8% by volume or more and 18% by volume or less. In the composition of the related art containing rubber or a resin and a thermal conductive filler, as described above, from the viewpoint of obtaining a higher thermal conductivity when the composition is made into a molded article, the content of the filler is more than 20% by volume in many cases. However, as the content of the filler increases, more problems, such as the decrease in strength of the molded article and cost increase, occur. On the other hand, in the composition according to the present exemplary embodiment, the shape factors SF1 and SF2 of the filler are made fall into predetermined ranges, resulting in excellent thermal conductivity even though the content of the filler is 20% by volume or less.

In a case where the composition according to the present exemplary embodiment is to be used for a heat dissipation sheet, from the viewpoint of sufficiently ensuring heat dissipation properties, the content of the filler is, for example, preferably 10% by volume or more and 50% by volume or less.

The aspect ratio of the filler is, for example, preferably 6 or less, more preferably 1 or more and 5 or less, and even more preferably 1 or more and 4 or less. In a case where the aspect ratio of the filler is 6 or less, it is easy to adjust the shape factors SF1 and SF2 of the filler to fall into the aforementioned ranges, and the thermal conductivity is further improved.

The aspect ratio of the filler means an arithmetic mean of aspect ratios determined for primary particles of the filler at random 10 points in the molded article of the composition by SEM observation.

### Resin and Rubber

Examples of the resin include a polyimide resin, a polyamide resin, a polyamide-imide resin, a polyether ether ester resin, a polyphenylene sulfide resin, a polyarylate resin, a polyether ether ketone resin, a polybenzimidazole polyester resin, and the like. From the viewpoint of strength and the like, for example, it is preferable that the resin contain a polyimide resin among the above. One resin may be used alone, or two or more resins may be used in combination.

Examples of the polyimide resin include an imidized polyamic acid (polyimide resin precursor) which is a polymer of a tetracarboxylic dianhydride and a diamine compound. Specific examples of the polyimide resin include a resin obtained by polymerizing equimolar amounts of a tetracarboxylic dianhydride and a diamine compound in a solvent to obtain a polyamic acid solution and imidizing the polyamic acid.

Examples of the tetracarboxylic dianhydride include both the aromatic and aliphatic tetracarboxylic dianhydride compounds. From the viewpoint of heat resistance, for example, an aromatic tetracarboxylic dianhydride compound is preferable.

Examples of the aromatic tetracarboxylic dianhydride include pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′,4,4′-biphenylethertetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furanetetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropyridene diphthalic dianhydride, 3,3′,4,4′-biphenyltetracarboxylic dianhydride, 2,3,3′,4′-biphenyltetracarboxylic dianhydride, bis(phthalic) phenylphosphine oxide dianhydride, p-phenylene-bis(triphenylphthalic)dianhydride, m-phenylene-bis(triphenylphthalic) dianhydride, bis(triphenylphthalic)-4,4′-diphenyl ether dianhydride, bis(triphenylphthalic)-4,4′-diphenylmethane dianhydride, and the like.

Examples of the aliphatic tetracarboxylic dianhydride include an aliphatic or alicyclic tetracarboxylic dianhydride such as butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic dianhydride, 3,5,6-tricarboxyorbornane-2-acetic dianhydride, 2,3,4,5-tetrahydrofuran tetracarboxylic dianhydride, 5-(2,5-dioxotetrahydrofuryl)-3-methyl-3-cyclohexene-1,2-dicarboxylic dianhydride, and bicyclo[2,2,2]-oct-7-ene-2,3,5,6-tetracarboxylic dianhydride; an aliphatic tetracarboxylic dianhydride having an aromatic ring such as 1,3,3a,4,5,9b-hexahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione, and the like.

Among the above, as the tetracarboxylic dianhydride, for example, an aromatic tetracarboxylic dianhydride is preferable. Specifically, for example, pyromellitic dianhydride, 3,3′,4,4′-biphenyltetracarboxylic dianhydride, 2,3,3′,4′-biphenyltetracarboxylic dianhydride, 3,3′,4,4′-biphenylethertetracarboxylic dianhydride, and 3,3′,4,4′-benzophenonetetracarboxylic dianhydride are preferable, pyromellitic dianhydride, 3,3′,4,4′-biphenyltetracarboxylic dianhydride, and 3,3′,4,4′-benzophenonetetracarboxylic dianhydride are more preferable, and 3,3′,4,4′-biphenyltetracarboxylic dianhydride is particularly preferable. One tetracarboxylic dianhydride may be used alone, or two or more tetracarboxylic dianhydrides may be used in combination.

In a case where two or more tetracarboxylic dianhydrides are used in combination, either aromatic tetracarboxylic dianhydrides or aliphatic tetracarboxylic dianhydrides may be used in combination, or an aromatic tetracarboxylic dianhydride and an aliphatic tetracarboxylic dianhydride may be used in combination.

A diamine compound is a compound having two amino groups in the molecular structure. Examples of the diamine compound include both the aromatic and aliphatic diamine compounds. Among these, for example, an aromatic diamine compound is preferable.

Examples of the diamine compound include aromatic diamines such as p-phenylenediamine, m-phenylenediamine, 4,4′-diaminodiphenylmethane, 4,4′-diaminodiphenylethane, 4,4′-diaminodiphenylether, 4,4′-diaminodiphenylsulfide, 4,4′-diaminodiphenylsulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenylether, 2,7-diaminofluorene, 2,2-bis(4-aminophenyl) hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl) biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl) fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, and 4,4′-bis[4-(4-amino-2-trifluoromethyl) phenoxy]-octafluorobiphenyl; aromatic diamines having two amino groups bonded to an aromatic ring and hetero atoms other than nitrogen atoms of the amino groups, such as diaminotetraphenyl thiophene; aliphatic and alicyclic diamines such as 1,1-metaxylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro-4,7-methanoindanylene dimethylenediamine, tricyclo[6,2,1,0^{2.7}]-undecylene dimethyldiamine, and 4,4′-methylenebis(cyclohexylamine), and the like.

Among the above, as the diamine compound, for example, an aromatic diamine compound is preferable. Specifically, for example, p-phenylenediamine, m-phenylenediamine, 4,4′-diaminodiphenylmethane, 4,4′-diaminodiphenylether, 3,4′-diaminodiphenylether, 4,4′-diaminodiphenylsulfide, and 4,4′-diaminodiphenylsulfone are preferable, and 4,4′-diaminodiphenylether and p-phenylenediamine are particularly preferable. One diamine compound may be used alone, or two or more diamine compounds may be used in combination. In a case where two or more diamine compounds are used in combination, either aromatic diamine compounds or aliphatic diamine compounds may be used in combination, or an aromatic diamine compound and an aliphatic diamine compound may be combined.

Among these, from the viewpoint of heat resistance, as a polyimide resin, for example, an aromatic polyimide resin (specifically, an imidized polyamic acid (a polyimide resin precursor) which is a polymer of an aromatic tetracarboxylic dianhydride and an aromatic diamine compound) is preferable.

The aromatic polyimide resin is, for example, more preferably a polyimide resin having a structural unit represented by the following General Formula (PI1).

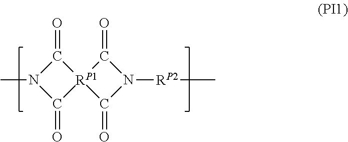

In General Formula (PI1), R^{P1} represents a phenyl group or a biphenyl group, and R^{P2} represents a divalent aromatic group.

Examples of the divalent aromatic group represented by R^{P2} include a phenylene group, a naphthyl group, a biphenyl group, a diphenyl ether group, and the like. As the divalent aromatic group, from the viewpoint of bending durability, for example, a phenylene group or a biphenyl group is preferable.

The number-average molecular weight of the polyimide resin is, for example, preferably 5,000 or more and 100,000 or less, more preferably 7,000 or more and 50,000 or less, and even more preferably 10,000 or more and 30,000 or less.

The number-average molecular weight of the polyimide resin is measured by gel permeation chromatography (GPC) under the following measurement conditions.
Column: Tosoh TSKgel α-M (7.8 mm I.D×30 cm)
Eluent: DMF (dimethylformamide)/30 mM LiBr/60 mM phosphoric acid
Flow rate: 0.6 mL/min
Injection amount: 60 μL
Detector: RI (differential refractive index detector)

Examples of the rubber include various rubber materials such as an isoprene rubber, a chloroprene rubber, an epichlorohydrin rubber, a butyl rubber, a polyurethane rubber, a silicone rubber, a fluororubber, a styrene-butadiene rubber, a butadiene rubber, a nitrile rubber, an ethylene propylene rubber, an ethylene-propylene-diene ternary polymerized rubber (EPDM), an acrylonitrile-butadiene copolymer rubber (NBR), a natural rubber, and a blended rubbers thereof, and foam thereof. From the viewpoint of strength and the like, for example, it is preferable that the rubber contain silicone rubber among the above. Examples of the silicone rubber include RTV silicone rubber, HTV silicone rubber, liquid silicone rubber, and the like. Specific examples thereof include polydimethyl silicone rubber (MQ), methyl vinyl silicone rubber (VMQ), methyl phenyl silicone rubber (PMQ), and fluorosilicone rubber (FVMQ), and the like. One rubber may be used alone, or two or more rubbers may be used in combination.

### Other Materials

The composition according to the present exemplary embodiment may further other materials in addition to the thermal conductive filler, the resin, and the rubber. Examples of the aforementioned other materials include an inorganic filler; additives such as a softener (such as paraffin-based softener), a processing aid (such as stearic acid), an antioxidant (such as amine-based antioxidant), a vulcanizing agent (such as sulfur, a metal oxide, or a peroxide), and the like.

### Molded Article

The molded article according to the present exemplary embodiment contains the composition according to the present exemplary embodiment.

According to the present exemplary embodiment, a molded article having excellent thermal conductivity is obtained.

The shape of the molded article is not particularly limited, and it is possible to adopt the shape of a known rubber molded article or resin molded article, such as a sheet shape, a cubic shape, a spherical shape, and an endless shape.

The manufacturing method of the molded article is not particularly limited. In a case where the molded article according to the present exemplary embodiment is a resin molded article, the molded article may be manufactured by a known resin-molding method such as injection molding, extrusion molding, blow molding, hot press molding, calendar molding, coating molding, cast molding, dipping molding, vacuum molding, or transfer molding. In a case where the molded article according to the present exemplary embodiment is a rubber molded article, the molded article may be manufactured by vulcanizing and foaming a kneaded product.

The molded article according to the present exemplary embodiment is used for an elastic layer and a substrate layer of a fixing member, a heat dissipation sheet, an artificial muscle, a pressure sensor, a tactile sensor, a dielectric sensor, and the like.

The shape of the molded article according to the present exemplary embodiment is selected according to the use. In a case where the molded article is used, for example, for an elastic layer and a substrate layer of a fixing member, a heat dissipation sheet, an artificial muscle, a pressure sensor, a tactile sensor, or the like, the molded article may be a layered molded article.

### Fixing Member

The fixing member according to the present exemplary embodiment has a substrate layer and an elastic layer provided on the substrate layer, and at least one of the substrate layer or the elastic layer contains the composition according to the present exemplary embodiment. As necessary, the fixing member may further have a surface layer on the elastic layer.

According to the present exemplary embodiment, a fixing member having excellent thermal conductivity is obtained.

In a case where the composition according to the present exemplary embodiment contains rubber, it is preferable that the composition according to the present exemplary embodiment be used, for example, for an elastic layer.

In a case where the composition according to the present exemplary embodiment contains a resin, it is preferable that the composition according to the present exemplary embodiment be used, for example, for a substrate layer.

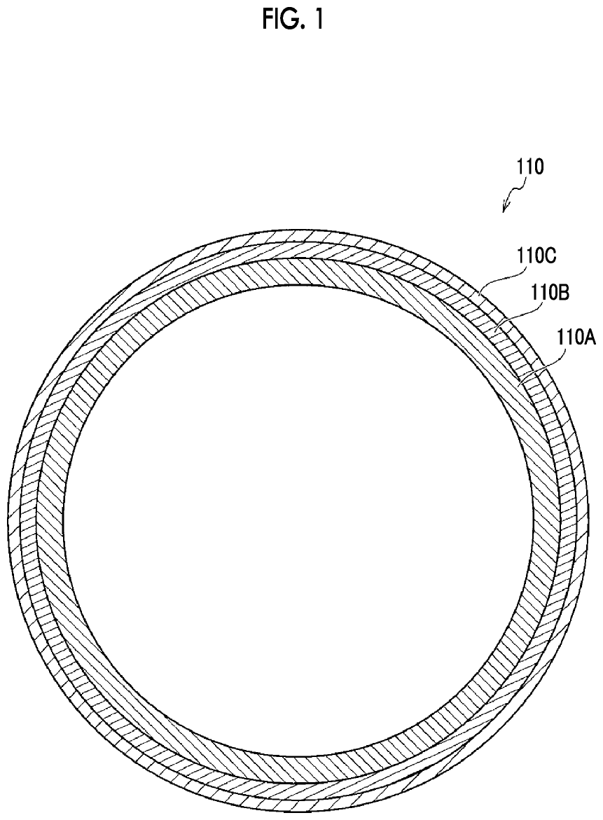

FIG. 1 is a schematic cross-sectional view showing an example of the fixing member according to the present exemplary embodiment.

As shown in FIG. 1, a fixing member 110 according to the present exemplary embodiment has, for example, a substrate 110A, an elastic layer 110B provided on the substrate 110A, and a surface layer 110C provided on the elastic layer 110B. Here, the surface layer 100C is a layer provided as necessary.

The fixing member 110 according to the present exemplary embodiment is not limited to the aforementioned layer configuration, and may have, for example, a layer configuration in which a metal layer or a protective layer for the metal layer is interposed between the substrate 110A and the elastic layer 110B as necessary.

Hereinafter, each constituent component of the fixing member according to the present exemplary embodiment will be described. Note that the reference numerals will not be described.

The fixing member may be in the form of a roll or belt.

### Substrate

In a case where the fixing member is in the form of a roll, examples of the substrate include a cylindrical substance configured with a metal (such as aluminum, SUS, iron, or copper), an alloy, ceramics, a fiber reinforced metal (FRM), or the like.

In a case where the fixing member is in the form of a roll, as for the outer diameter and a wall thickness of the substrate, for example, the outer diameter may be 10 mm or more and 50 mm or less. For example, in a case where the fixing member is made of aluminum, the thickness is 0.5 mm or more and 4 mm or less, and in a case where the fixing member is made of stainless steel (SUS) or iron, the thickness is 0.1 mm or more and 2 mm or less.

In a case where the fixing member is in the form of a belt, examples of the substrate include a metal belt (for example, a metal belt of nickel, aluminum, stainless steel, or the like) and a resin belt (for example, a resin belt of a polyimide resin, polyamide-imide, polyphenylene sulfide, polyether ether ketone, or polybenzimidazole).

A conductive powder or the like may be added to and dispersed in the resin belt such that the volume resistivity is controlled. Specifically, examples of the resin belt include a polyimide belt in which carbon black is added and dispersed such that the volume resistivity is controlled. In addition, examples of the resin belt include a belt formed by combining both ends of a long polyimide sheet on a puzzle and performing thermocompression by using a thermocompression member to obtain a belt-shaped product.

In a case where the fixing member is in the form of a belt, the thickness of the substrate may be, for example, 20 μm or more and 200 μm or less. For example, the thickness of the belt is desirably 30 μm or more and 150 μm or less, and more desirably 40 μm or more and 130 μm or less.

### Elastic Layer

In the elastic layer, the molded product according to the present exemplary embodiment is used. In the elastic layer, an elastic material is used as a polymer material of the molded product.

Various additives may be mixed in the elastic layer. Examples of the additives include a softener (such as a paraffin-based softener), a processing aid (such as stearic acid), an antioxidant (such as an amine-based antioxidant), a vulcanizing agent (such as sulfur, a metal oxide, or a peroxide), a functional filler (such as alumina), and the like.

The thickness of the elastic layer may be, for example, 20 μm or more and 1,000 μm or less, and is, for example, preferably 30 μm or more and 800 μm or less, and more preferably 100 μm or more and 500 μm or less.

### Surface Layer

The surface layer is configured, for example, with a heat-resistant release material.

Examples of the heat-resistant release material include fluororubber, a fluororesin, a silicone resin, a polyimide resin, and the like.

Among these, for example, a fluororesin is preferable as the heat-resistant release material.

Specific examples of the fluororesin include a tetrafluoroethylene/perfluoroalkylvinyl ether copolymer (PFA), polytetrafluoroethylene (PTFE), a tetrafluoroethylene/hexafluoropropylene copolymer (FEP), a polyethylene/tetrafluoroethylene copolymer (ETFE), polyvinylidene fluoride (PVDF), polychlorotrifluoroethylene (PCTFE), vinyl fluoride (PVF), and the like.

In view of suppressing density unevenness of an image to be formed, the thickness of the surface layer may be, for example, 5 μm or more and 100 μm or less. The thickness of the surface layer is, for example, preferably 5 μm or more and 50 μm or less, and more preferably 10 μm or more and 40 μm or less.

In order to enhance the adhesiveness to the elastic layer, an adhesion treatment may be performed in advance to the inner surface of a tube for forming the surface layer. Examples of the adhesion treatment include a liquid ammonia treatment, a sodium naphthalene treatment, an excimer laser treatment, and a plasma treatment. After the treatment, both ends of the fluororesin tube are cut in a target length, thereby obtaining a fixing member.

### Use of Fixing Member

The fixing member according to the present exemplary embodiment is used, for example, for any of a heating roll, a pressure roll, a heating belt, and a pressure belt. Examples of heat sources in the heating roll and the heating belt include a method of heating from an external heat source, a method of heating by an electromagnetic induction method, and the like.

### Fixing Device

The fixing device according to the present exemplary embodiment is a fixing device including a first rotary member and a second rotary member arranged in contact with the outer surface of the first rotary member, in which at least one of the first rotary member or the second rotary member is the fixing member according to the present exemplary embodiment.

According to the present exemplary embodiment, a fixing device including a fixing member having excellent thermal conductivity is obtained.

Hereinafter, as first and second exemplary embodiments, a fixing device including a heating belt and a pressure roll will be described. Moreover, in the first and second exemplary embodiments, the fixing member according to the present exemplary embodiment may be used for both the heating belt and the pressure roll.

The fixing device according to the present exemplary embodiment is not limited to the first and second exemplary embodiments, and may be a fixing device including a heating roll or a heating belt and a pressure belt. Furthermore, the fixing member according to the present exemplary embodiment may be used for all the heating roll, the heating belt, and the pressure belt.

In addition, the fixing device according to the present exemplary embodiment is not limited to the first and second exemplary embodiments, and may be an electromagnetic induction heating-type fixing device.

### First Exemplary Embodiment of Fixing Device

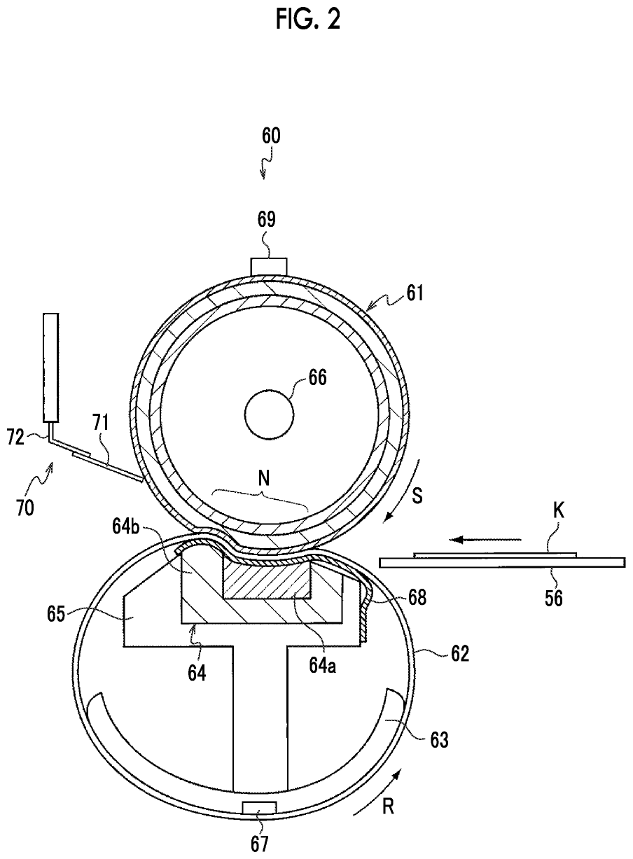

The fixing device according to the first exemplary embodiment will be described. FIG. 2 is a schematic view showing an example of the fixing device according to the first exemplary embodiment.

As shown in FIG. 2, a fixing device 60 according to the first exemplary embodiment is configured, for example, with a heating roll 61 (an example of the first rotary member) driven to rotate, a pressure belt 62 (an example of the second rotary member), and a pressing pad 64 (an example of a pressing member) that presses the heating roll 61 via the pressure belt 62.

On the pressing pad 64, for example, the pressure belt 62 and the heating roll 61 may be relatively pressed. Therefore, the pressure belt 62 may be pressed on the heating roll 61, or the heating roll 61 may be pressed on the pressure belt 62.

A halogen lamp 66 (an example of a heating device) is provided on the inside of the heating roll 61. The heating device is not limited to the halogen lamp, and other heating members that generate heat may be used.

Meanwhile, for example, a thermosensitive element 69 is arranged in contact with the surface of the heating roll 61. The lighting of the halogen lamp 66 is controlled based on the temperature measured by the thermosensitive element 69, and the surface temperature of the heating roll 61 is kept at a target set temperature (for example, 150° C.).

The pressure belt 62 is rotatably supported, for example, by the pressing pad 64 and a belt running guide 63 arranged on the inside of the pressure belt 62. In a nip region N (nip portion), the pressure belt 62 is arranged such that the pressure belt 62 is pressed on the heating roll 61 by the pressing pad 64.

The pressing pad 64 is arranged, for example, on the inside of the pressure belt 62 such that the pressing pad 64 is in a state of being pressed on the heating roll 61 via the pressure belt 62, and the nip region N is formed between the pressing pad 64 and the heating roll 61.

In the pressing pad 64, for example, a front nip member 64a for securing a wide nip region N is arranged on the entrance side of the nip region N, and a peeling nip member 64b for distorting the heating roll 61 is arranged on the exit side of the nip region N.

In order to reduce the sliding resistance between an inner peripheral surface of the pressure belt 62 and the pressing pad 64, for example, a sheet-like sliding member 68 is provided on a surface of the front nip member 64a and the peeling nip member 64b, the surface being in contact with the pressure belt 62. The pressing pad 64 and the sliding member 68 are held by a holding member 65 made of a metal.

The sliding member 68 is provided such that the sliding surface thereof is in contact with, for example, the inner peripheral surface of the pressure belt 62, and is involved in holding and supplying of oil existing between the sliding member 68 and the pressure belt 62.

For example, the holding member 65 has a configuration in which the belt running guide 63 is attached to the holding member 65, and the pressure belt 62 rotates.

The heating roll 61 rotates, for example, in the direction of an arrow S by a driving motor not shown in the drawing. Following the rotation, the pressure belt 62 rotates in the direction of an arrow R opposite to the rotation direction of the heating roll 61. That is, for example, the heating roll 61 rotates clockwise in FIG. 2, while the pressure belt 62 rotates counterclockwise.

Then, paper K (an example of a recording medium) having an unfixed toner image is guided, for example, by a fixing entrance guide 56 and transported to the nip region N. While the paper K is passing through the nip region N, the toner image on the paper K is fixed by the pressure and heat acting on the nip region N.

In the fixing device 60 according to the first exemplary embodiment, for example, by the front nip member 64a in the form of a recess conforming to the outer peripheral surface of the heating roll 61, a wider nip region N is secured, compared to a configuration having no front nip member 64a.

Furthermore, the fixing device 60 according to the first exemplary embodiment is configured, for example, with the peeling nip member 64b that is arranged to protruding from the outer peripheral surface of the heating roll 61, such that the heating roll 61 is locally distorted much in the exit region of the nip region N.

In a case where the peeling nip member 64b is arranged as above, for example, the paper K after fixing passes through a portion that is locally distorted much while passing through a peeling nip region. Therefore, the paper K is easily peeled off from the heating roll 61.

As an auxiliary device for peeling, for example, a peeling member 70 is provided on a downstream side of the nip region N of the heating roll 61. The peeling member 70 is, for example, held by a holding member 72, in a state where a peeling claw 71 is close to the heating roll 61 in a direction (counter direction) opposite to the rotation direction of the heating roll 61.

### Second Exemplary Embodiment of Fixing Device

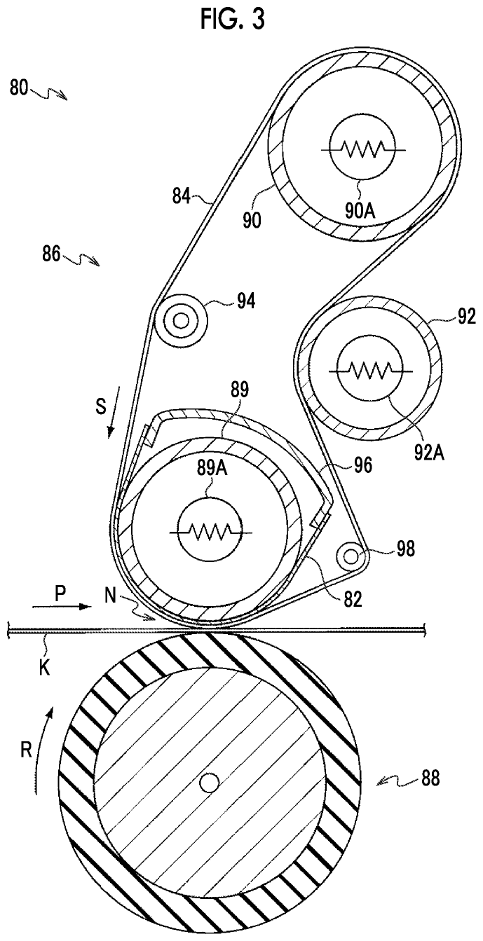

The fixing device according to the second exemplary embodiment will be described. FIG. 3 is a schematic view showing an example of the fixing device according to the second exemplary embodiment.

As shown in FIG. 3, a fixing device 80 according to the second exemplary embodiment is configured, for example, with a fixing belt module 86 including a heating belt 84 (an example of the first rotary member) and a pressure roll 88 (an example of the second rotary member) arranged in a state of being pressed on a heating belt 84 (fixing belt module 86). For example, a nip region N (nip portion) where the heating belt 84 (fixing belt module 86) and the pressure roll 88 come into contact with each other is formed. In the nip region N, paper K (an example of a recording medium) is pressed and heated such that a toner image is fixed.

The fixing belt module 86 includes, for example, an endless heating belt 84, a heating and pressing roll 89 around which the heating belt 84 is wound on the side of the pressure roll 88 and which is driven to rotate by the rotational force of a motor (not shown in the drawing) and presses the heating belt 84 from an inner peripheral surface thereof toward the pressure roll 88, and a support roll 90 which supports the heating belt 84 from the inside at a position different from the heating and pressing roll 89.

The fixing belt module 86 is provided with, for example, a support roll 92 which is disposed outside the heating belt 84 and regulates the circulating path thereof, a posture correction roll 94 which corrects the posture of the heating belt 84 from the heating and pressing roll 89 to the support roll 90, and a support roll 98 which applies tension to the heating belt 84 from the inner peripheral surface on the downstream side of the nip region N which is a region where the heating belt 84 (fixing belt module 86) and the pressure roll 88 come into contact with each other.

The fixing belt module 86 is provided, for example, such that a sheet-like sliding member 82 is interposed between the heating belt 84 and the heating and pressing roll 89.

The sliding member 82 is provided such that the sliding surface thereof is in contact with, for example, the inner peripheral surface of the heating belt 84, and is involved in holding and supplying of oil existing between the sliding member 82 and the heating belt 84.

The sliding member 82 is provided, for example, in a state where both ends thereof are being supported by a support member 96.

On the inside of the heating and pressing roll 89, for example, a halogen heater 89A (an example of a heating device) is provided.

The support roll 90 is, for example, a cylindrical roll formed of aluminum. A halogen heater 90A (an example of a heating device) is provided on the inside of the support roll 90, such that the heating belt 84 is heated from the inner peripheral surface side.

Both end portions of the support roll 90 are provided with, for example, spring members (not shown in the drawing) pressing the heating belt 84 to the outside.

The support roll 92 is, for example, a cylindrical roll made of aluminum. A release layer consisting of a fluororesin having a thickness of 20 μm is formed on a surface of the support roll 92.

The release layer of the support roll 92 is formed, for example, to prevent a toner or paper powder from the outer peripheral surface of the heating belt 84 from depositing on the support roll 92.

For example, a halogen heater 92A (an example of a heating source) is disposed on the inside of the support roll 92, such that the heating belt 84 is heated from the outer peripheral surface side.

That is, for example, the fixing belt module 86 is configured such that the heating belt 84 is heated by the heating and pressing roll 89, the support roll 90, and the support roll 92.

The posture correction roll 94 is, for example, a cylindrical roll made of aluminum, and an end position measuring mechanism (not shown in the drawing) for measuring the end position of the heating belt 84 is disposed in the vicinity of the posture correction roll 94.

The posture correction roll 94 is provided with, for example, an axial displacement mechanism (not shown in the drawing) which displaces the contact position of the heating belt 84 in the axial direction according to the measurement result of the end position measuring mechanism, and is configured to control meandering of the heating belt 84.

The pressure roll 88 is provided, for example, such that the pressure roll 88 is rotatably supported and pressed on the site of the heating and pressing roll 89 around which the heating belt 84 is wound by an urging device such as a spring not shown in the drawing. As a result, as the heating belt 84 (heating and pressing roll 89) of the fixing belt module 86 rotates and moves in the direction of the arrow S, the pressure roll 88 follows the heating belt 84 (heating and pressing roll 89) and rotates and moves in the direction of the arrow R.

In a case where the paper K having an unfixed toner image (not shown in the drawing) is transported in the direction of an arrow P and is guided to the nip region N of the fixing device 80, the toner image is fixed due to the pressure and heat acting in the nip region N.

For the fixing device 80 according to the second exemplary embodiment, an embodiment has been described in which a halogen heater (halogen lamp) is used as an example of a heating source. However, the fixing device is not limited thereto, and a radiation lamp heating element (a heating element generating radiation (such as infrared rays) and a resistance heating element (a heating element generating Joule heat by passing an electric current through a resistor: for example, a heating element obtained by forming a film with a resistor on a ceramic substrate and baking the resultant) other than the halogen heater may be used.

### Image Forming Apparatus

The image forming apparatus of the present exemplary embodiment includes an image holder, a charging device that charges a surface of the image holder, an electrostatic latent image forming device that forms an electrostatic latent image on the charged surface of the image holder, a developing device that develops the electrostatic latent image formed on the surface of the image holder with a toner to form a toner image, a transfer device that transfers the toner image formed on the surface of the image holder to a recording medium, and a fixing device that fixes the toner image to the recording medium.

Hereinafter, the image forming apparatus according to the present exemplary embodiment will be described with reference to a drawing.

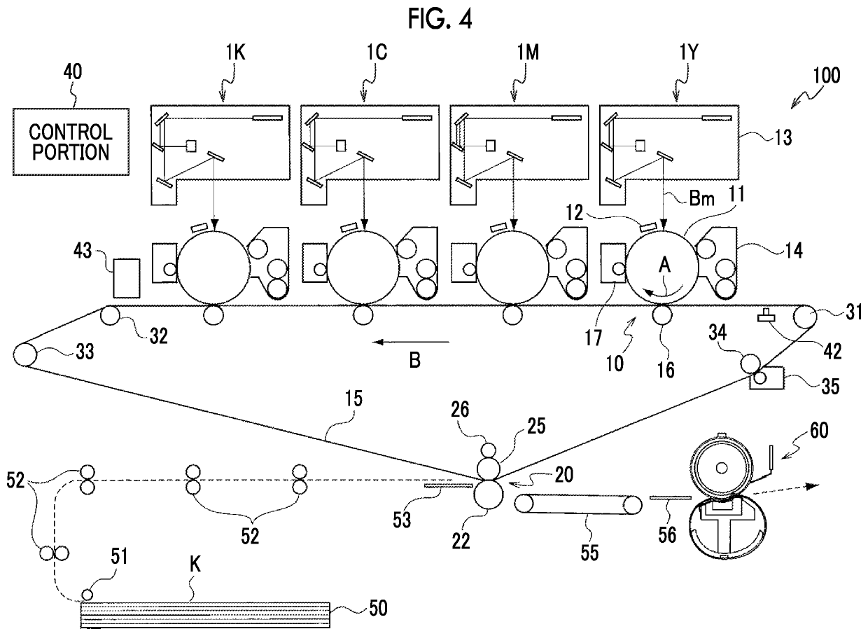

FIG. 4 is a schematic configuration view showing the configuration of the image forming apparatus according to the present exemplary embodiment.

As shown in FIG. 4, an image forming apparatus 100 according to the present exemplary embodiment is, for example, an intermediate transfer-type image forming apparatus that is generally called a tandem type, and includes a plurality of image forming units 1Y, 1M, 1C, and 1K in which a toner image of each color component is formed by an electrophotographic method, a primary transfer portion 10 that performs sequential transfer (primary transfer) of the toner image of each color component formed by each of the image forming units 1Y, 1M, 1C, and 1K to an intermediate transfer belt 15, a secondary transfer portion 20 that performs batch transfer (secondary transfer) of the overlapped toner images transferred to the intermediate transfer belt 15 to paper K as a recording medium, and a fixing device 60 that fixes the images transferred by the secondary transfer on the paper K. The image forming apparatus 100 also has a control portion 40 that controls the operation of each device (each portion).

The fixing device 60 is the fixing device 60 according to the first exemplary embodiment described above. The image forming apparatus 100 may be configured with the fixing device 80 according to the second exemplary embodiment described above.

Each of the image forming units 1Y, 1M, 1C, and 1K of the image forming apparatus 100 includes a photoreceptor 11 that rotates in the direction of an arrow A, as an example of an image holder that holds a toner image formed on the surface.

Around the photoreceptor 11, there are provided a charger 12 for charging the photoreceptor 11 as an example of a charging device and a laser exposure machine 13 for drawing an electrostatic latent image on the photoreceptor 11 as an example of a latent image forming device (in FIG. 4, the exposure beam is represented by a mark Bm).

Around the photoreceptor 11, as an example of a developing device, there are provided a developing machine 14 that contains toners of each color component and makes the electrostatic latent image on the photoreceptor 11 into a visible image by using the toners and a primary transfer roll 16 that transfers toner images of each color component formed on the photoreceptor 11 to the intermediate transfer belt 15 by the primary transfer portion 10. Around the photoreceptor 11, there are provided a photoreceptor cleaner 17 that removes the residual toner on the photoreceptor 11 and devices for electrophotography, such as the charger 12, the laser exposure machine 13, the developing machine 14, the primary transfer roll 16, and the photoreceptor cleaner 17, that are arranged in sequence along the rotation direction of the photoreceptor 11. These image forming units 1Y, 1M, 1C, and 1K are substantially linearly arranged in order of yellow (Y), magenta (M), cyan (C), and black (K) from the upstream side of the intermediate transfer belt 15.

The intermediate transfer belt 15 which is an intermediate transfer member is configured with a film-shaped pressure belt including a base layer that is a resin such as polyimide or polyamide and containing an appropriate amount of an antistatic agent such as carbon black. Furthermore, the intermediate transfer belt 15 is configured to have a volume resistivity of 10⁶ Ωcm or more and 10¹⁴ Ωcm or less and has a thickness of about, for example, 0.1 mm.

By various rolls, the intermediate transfer belt 15 is driven to circulate (rotate) in a direction B shown in FIG. 4 at a speed fit for the purpose. The image forming apparatus 100 has, as the various rolls, a driving roll 31 that is driven by a motor (not shown in the drawing) excellent in maintaining a constant speed and rotates the intermediate transfer belt 15, a support roll 32 that supports the intermediate transfer belt 15 substantially linearly extending along the arrangement direction of the photoreceptors 11, a tension applying roll 33 that applies tension to the intermediate transfer belt 15 and functions as a correcting roll preventing meandering of the intermediate transfer belt 15, a back roll 25 that is provided in the secondary transfer portion 20, and a back roll 34 for cleaning that is provided in a cleaning portion scrapping off the residual toner on the intermediate transfer belt 15.

The primary transfer portion 10 is configured with the primary transfer roll 16 that is arranged to face the photoreceptor 11 across the intermediate transfer belt 15. The primary transfer roll 16 is configured with a core and a sponge layer as an elastic layer fixed around the core. The core is a cylindrical rod configured with a metal such as iron or SUS. The sponge layer is a sponge-like cylindrical roll which is formed of blended rubber of NBR, SBR, and EPDM mixed with a conducting agent such as carbon black and has a volume resistivity of 10^{7.5} Ωcm or more and 10^{8.5} Ωcm or less.

The primary transfer roll 16 is arranged to be pressed on the photoreceptor 11 across the intermediate transfer belt 15, and the polarity of voltage (primary transfer bias) applied to the primary transfer roll 16 is opposite to the charging polarity (negative polarity, the same shall apply hereinafter) of the toner. As a result, the toner image on each photoreceptor 11 is sequentially electrostatically sucked onto the intermediate transfer belt 15, which leads to the formation of overlapped toner images on the intermediate transfer belt 15.

The secondary transfer portion 20 comprises the back roll 25 and a secondary transfer roll 22 that is arranged on a toner image-holding surface side of the intermediate transfer belt 15.

The surface of the back roll 25 is configured with a tube of blended rubber of EPDM and NBR in which carbon is dispersed, and the inside of the back roll 25 is configured with EPDM rubber. Furthermore, the back roll 25 is formed such that the surface resistivity thereof is 10⁷Ω/□ or more and 10¹⁰Ω/□ or less. The hardness of the back roll 25 is set to, for example, 70° (ASKER C: manufactured by KOBUNSHI KEIKI CO., LTD., the same shall apply hereinafter). The back roll 25 is arranged on the back surface side of the intermediate transfer belt 15 to configure a counter electrode of the secondary transfer roll 22. A power supply roll 26 made of a metal to which secondary transfer bias is stably applied is arranged to come into contact with the back roll 25.

The secondary transfer roll 22 is configured with a core and a sponge layer as an elastic layer fixed around the core. The core is a cylindrical rod configured with a metal such as iron or SUS. The sponge layer is a sponge-like cylindrical roll which is formed of blended rubber of NBR, SBR, and EPDM mixed with a conducting agent such as carbon black and has a volume resistivity of 10^{7.5} Ωcm or more and 10^{8.5} Ωcm or less.

The secondary transfer roll 22 is arranged to be pressed on the back roll 25 across the intermediate transfer belt 15. The secondary transfer roll 22 is grounded such that the secondary transfer bias is formed between the secondary transfer roll 22 and the back roll 25, which induces secondary transfer of the toner image onto the paper K transported to the secondary transfer portion 20.

On the downstream side of the secondary transfer portion 20 of the intermediate transfer belt 15, an intermediate transfer belt cleaner 35 separable from the intermediate transfer belt 15 is provided which removes the residual toner or paper powder on the intermediate transfer belt 15 remaining after the secondary transfer and cleans the surface of the intermediate transfer belt 15.

The intermediate transfer belt 15, the primary transfer portion 10 (primary transfer roll 16), and the secondary transfer portion 20 (secondary transfer roll 22) correspond to an example of the transfer device.

On the other hand, on the upstream side of the yellow image forming unit 1Y, a reference sensor (home position sensor) 42 is arranged which generates a reference signal to be a reference for taking the image forming timing in each of the image forming units 1Y, 1M, 1C, and 1K. On the downstream side of the black image forming unit 1K, an image density sensor 43 for adjusting image quality is arranged. The reference sensor 42 recognizes a mark provided on the back side of the intermediate transfer belt 15 and generates a reference signal. Each of the image forming units 1Y, 1M, 1C, and 1K is configured such that these units start to form images according to the instruction from the control portion 40 based on the recognition of the reference signal.

The image forming apparatus according to the present exemplary embodiment includes, as a transport device for transporting the paper K, a paper storage portion 50 that stores the paper K, a paper feeding roll 51 that takes out and transports the paper K stacked in the paper storage portion 50 at a predetermined timing, a transport roll 52 that transports the paper K transported by the paper feeding roll 51, a transport guide 53 that sends the paper K transported by the transport roll 52 to the secondary transfer portion 20, a transport belt 55 that transports the paper K transported after going through secondary transfer by the secondary transfer roll 22 to the fixing device 60, and a fixing entrance guide 56 that guides the paper K to the fixing device 60.

Next, the basic image forming process of the image forming apparatus according to the present exemplary embodiment will be described.

In the image forming apparatus according to the present exemplary embodiment, image data output from an image reading device not shown in the drawing, a personal computer (PC) not shown in the drawing, or the like is subjected to image processing by an image processing device not shown in the drawing, and then the image forming units 1Y, 1M, 1C, and 1K perform the image forming operation.

In the image processing device, image processing, such as shading correction, misregistration correction, brightness/color space conversion, gamma correction, or various image editing works such as frame erasing or color editing and movement editing, is performed on the input image data. The image data that has undergone the image processing is converted into color material gradation data of 4 colors, Y, M, C, and K, and is output to the laser exposure machine 13.

In the laser exposure machine 13, according to the input color material gradation data, for example, the photoreceptor 11 of each of the image forming units 1Y, 1M, 1C, and 1K is irradiated with the exposure beam Bm emitted from a semiconductor laser. The surface of each of the photoreceptors 11 of the image forming units 1Y, 1M, 1C, and 1K is charged by the charger 12 and then scanned and exposed by the laser exposure machine 13. In this way, an electrostatic latent image is formed. By each of the image forming units 1Y, 1M, 1C, and 1K, the formed electrostatic latent image is developed as a toner image of each of the colors Y, M, C, and K.

In the primary transfer portion 10 where each photoreceptor 11 and the intermediate transfer belt 15 come into contact with each other, the toner images formed on the photoreceptors 11 of the image forming units 1Y, 1M, 1C, and 1K are transferred onto the intermediate transfer belt 15. More specifically, in the primary transfer portion 10, by the primary transfer roll 16, a voltage (primary transfer bias) with a polarity opposite to the charging polarity (negative polarity) of the toner is applied to the substrate of the intermediate transfer belt 15, and the toner images are sequentially overlapped on the surface of the intermediate transfer belt 15 and subjected to primary transfer.

After the primary transfer by which the toner images are sequentially transferred to the surface of the intermediate transfer belt 15, the intermediate transfer belt 15 moves, and the toner images are transported to the secondary transfer portion 20. In a case where the toner images are transported to the secondary transfer portion 20, in the transport device, the paper feeding roll 51 rotates in accordance with the timing at which the toner images are transported to the secondary transfer portion 20, and the paper K having the target size is fed from the paper storage portion 50. The paper K fed from the paper feeding roll 51 is transported by the transport roll 52, passes through the transport guide 53, and reaches the secondary transfer portion 20. Before reaching the secondary transfer portion 20, the paper K is temporarily stopped, and a positioning roll (not shown in the drawing) rotates according to the movement timing of the intermediate transfer belt 15 holding the toner images, so that the position of the paper K is aligned with the position of the toner images.

In the secondary transfer portion 20, via the intermediate transfer belt 15, the secondary transfer roll 22 is pressed on the back roll 25. At this time, the paper K transported at the right timing is interposed between the intermediate transfer belt 15 and the secondary transfer roll 22. At this time, in a case where a voltage (secondary transfer bias) with the same polarity as the charging polarity (negative polarity) of the toner is applied from the power supply roll 26, a transfer electric field is formed between the secondary transfer roll 22 and the back roll 25. In the secondary transfer portion 20 pressed by the secondary transfer roll 22 and the back roll 25, the unfixed toner images held on the intermediate transfer belt 15 are electrostatically transferred onto the paper K in a batch.

Thereafter, the paper K to which the toner images are electrostatically transferred is transported in a state of being peeled off from the intermediate transfer belt 15 by the secondary transfer roll 22, and is transported to the transport belt 55 provided on the downstream side of the secondary transfer roll 22 in the paper transport direction. The transport belt 55 transports the paper K to the fixing device 60 according to the optimum transport speed in the fixing device 60. The unfixed toner images on the paper K transported to the fixing device 60 are fixed on the paper K by being subjected to a fixing treatment by heat and pressure by the fixing device 60. Then, the paper K on which a fixed image is formed is transported to an ejected paper-storing portion (not shown in the drawing) provided in an ejection portion of the image forming apparatus.

Meanwhile, after the transfer to the paper K is finished, the residual toner remaining on the intermediate transfer belt 15 is transported to the cleaning portion as the intermediate transfer belt 15 rotates, and is removed from the intermediate transfer belt 15 by the back roll 34 for cleaning and an intermediate transfer belt cleaner 35.

Hitherto, the exemplary embodiments of the present invention have been described, but the present invention is not limited to the above exemplary embodiments. It goes without saying that various modifications, changes, and improvements can be made as long as the requirements of the present invention are satisfied.

### EXAMPLES

Hereinafter, the present invention will be more specifically described with reference to examples. However, the present invention is not limited to the following examples. In the following description, unless otherwise specified, “parts” and “%” are based on mass in all cases.

### Example 1

A silicone rubber stock solution (X-34-1053 manufactured by Shin-Etsu Chemical Co., Ltd., concentration of solid content: 60% by mass, solvent: butyl acetate) and a thermal conductive filler of type shown in Table 1 having the number-average particle size shown in Table 1 are mixed together such that the amount of the thermal conductive filler with respect to the total solid content in the composition equals the quantity shown in Table 1, thereby obtaining a rubber composition. A substrate made of a polyimide resin is coated with the obtained composition for forming a molded product to form a coating film, and the coating film is heated at 100° C. for 30 minutes, thereby obtaining a rubber molded article with an elastic layer having a film thickness of 450 μm.

### Example 2

A polyamic acid solution (manufactured by UNITIKA LTD.: TX-HMM (polyimide varnish), concentration of solid content: 18% by mass, solvent: NMP) and a thermal conductive filler of type shown in Table 1 having the number-average particle size shown in Table 1 are mixed together such that the amount of the thermal conductive filler with respect to the total solid content in the composition equals the quantity shown in Table 1, thereby preparing a coating liquid for forming a substrate layer. By a flow coating method (conditions: mold rotation speed of 500 rpm, movement speed of a discharge portion in the direction of the rotation axis of the mold of 100 mm/min), a cylindrical mold is coated with the obtained coating liquid to form a coating film. The coating film is baked at 380° C., thereby obtaining a resin molded article having a film thickness of 80 μm.

### Example 3, Example 9, Example 10, Comparative Example 1, and Comparative Example 5

A rubber molded article is obtained in the same manner as in Example 1, except that the type and amount of the thermal conductive fillers are changed according to Table 1.

### Examples 4 to 8 and Comparative Examples 2 to 4

A resin molded article is obtained in the same manner as in Example 1, except that the type and amount of thermal conductive fillers are changed according to Table 1.

### Reference Example 1

A coating film is formed in the same manner as in Example 2, except that the type and amount of the thermal conductive filler are changed according to Table 1. Thereafter, the coating film sample is dried in a thermostatic bath at 70° C. for 3 hours and then at 120° C. for 3 hours in this order in a state where an AC voltage of 1 kVrms and a frequency of 60 Hz are applied thereto, thereby obtaining a dry film. The dry film is then baked at 380° C., thereby forming a resin molded article having a film thickness of 80 μm.

The shape factor SF1 and the shape factor SF2 of the thermal conductive filler in the molded article of each example are values obtained by the measurement method described above.

Details of the filler of each example are as follows.
Silicon carbide of Examples 1 and 8: GMF-S (manufactured by Pacific Rundum Co., Ltd.)
Silicon nitride of Example 2, Example 6, and Example 7: β-Si3N4 (manufactured by TOMOE Engineering Co., Ltd.)
Boron nitride of Example 3: UHP-1K (manufactured by Showa Denko K. K.)
Aluminum nitride in Example 4: FAN-f05 (manufactured by Furukawa Denshi Co., Ltd.)
Aluminum Nitride of Example 5: THERMALNITE (manufactured by U-MAP Co, Ltd.)
Graphite of Example 9: ACG-45J (manufactured by Fuji Graphite Works Co., Ltd.)
Aluminum oxide of Example 10: AP10 (manufactured by DIC CORPORATION)
Aluminum oxide of Comparative Example 1: DAM-20 (manufactured by Denka Company Limited.)
Graphite of Comparative Example 2: FT-2 (manufactured by East Japan Carbon Co., Ltd.)
Aluminum oxide of Comparative Example 3: DAM-3 (manufactured by Denka Company Limited.)
Carbon nanotubes of Comparative Example 4 and Reference Example 1: VGCF-H (manufactured by Showa Denko K. K.)
Boron nitride of Comparative Example 5: XGP (manufactured by Denka Company Limited.)

### Evaluation of Thermal Conductivity

The thermal conductivity of the molded article of each example is measured according to the method described above. The results are shown in Table 1.

### Evaluation of Bending Resistance

For the molded article of each example, the bending resistance (MIT folding endurance) is measured by the following measurement method.

A 150 mm×15 mm test piece is prepared from the molded article of each example. Based on JIS-C5016, the number of times the test piece is bent back and forth until the test piece breaks is measured. For the same sample, the measurement is performed 10 times, and the average of the results is adopted as an evaluation result of bending resistance. The result is used as measurement data. As a measuring machine, MIT abrasion and fatigue endurance tester MIT-DA from Toyo Seiki Seisaku-sho, Ltd. is used.

### Evaluation Standard

A: 10,000 or more
B: 2,500 or more
C: less than 2,500

TABLE 1

| | | Thermal conductive filler | | | | | | | |
|---|---|---|---|---|---|---|---|---|---|
| | | | | | | | Number- | | |
| | Type of | | Amount | | | | average | Thermal | |
| | resin or | | (% by | | | Aspect | particle size | conductivity | Bending |
| | rubber | Filler type | volume) | SF1 | SF2 | ratio | (μm) | (W/mK) | resistance |
| Example 1 | Si rubber | Silicon carbide | 15 | 163 | 185 | 2.5 | 16.1 | 2.36 | A |
| Example 2 | PI | Silicon nitride | 15 | 127 | 205 | 1.4 | 3.2 | 1.62 | A |
| Example 3 | Si rubber | Boron nitride | 15 | 142 | 298 | 1.9 | 28.3 | 1.93 | A |
| Example 4 | PI | Aluminum nitride | 15 | 124 | 142 | 1.5 | 2.9 | 1.24 | A |
| Example 5 | PI | Aluminum nitride | 15 | 383 | 281 | 5.6 | 8.3 | 1.31 | A |
| Example 6 | PI | Silicon nitride | 4.8 | 127 | 205 | 1.4 | 3.2 | 1.21 | A |
| Example 7 | PI | Silicon nitride | 35 | 127 | 205 | 1.4 | 3.2 | 1.99 | B |
| Example 8 | PI | Silicon carbide | 15 | 163 | 185 | 2.5 | 16.1 | 2.31 | B |
| Example 9 | Si rubber | Graphite | 15 | 231 | 320 | 3.8 | 42.8 | 1.79 | B |
| Example 10 | Si rubber | Aluminum oxide | 15 | 165 | 218 | 2.7 | 11.0 | 1.29 | A |
| Comparative | Si rubber | Aluminum oxide | 15 | 116 | 169 | 1.2 | 24.3 | 0.58 | A |
| Example 1 | | | | | | | | | |
| Comparative | PI | Graphite | 15 | 210 | 346 | 3.4 | 1.9 | 0.74 | B |
| Example 2 | | | | | | | | | |
| Comparative | PI | Aluminum oxide | 15 | 112 | 128 | 1.2 | 3.5 | 0.45 | A |
| Example 3 | | | | | | | | | |
| Comparative | PI | Carbon nanotubes | 15 | 418 | 327 | 6.4 | 3.0 | 0.88 | B |
| Example 4 | | | | | | | | | |
| Comparative | Si rubber | Boron nitride | 15 | 2356 | 1019 | 30 | 35.0 | 0.67 | B |
| Example 5 | | | | | | | | | |
| Reference | PI | Carbon nanotubes | 15 | 418 | 327 | 6.4 | 3.0 | 1.78 | C |
| Example 1 | | | | | | | | | |

As shown in Table 1, it has been found that the molded articles containing the compositions of examples have higher thermal conductivity compared to the molded articles containing the compositions of comparative examples. In addition, as shown in Table 1, it has been found that the molded articles containing the compositions of examples have higher bending resistance in the plane direction, compared to the molded article containing the composition of Reference Example 1 (that is, the molded article containing the composition that contains an alignable filler of the related art having anisotropy).
(((1))) A composition comprising:
at least one or more thermal conductive fillers; and
a resin or rubber,
wherein the fillers have a shape factor SF1 of 120 or more and 400 or less and a shape factor SF2 of 140 or more and 325 or less.
(((2))) The composition according to (((1))) comprising:
the resin.
(((3))) The composition according to (((1))) or (((2))),
wherein a number-average particle size of the fillers is 0.5 μm or more and 10 μm or less.
(((4))) The composition according to any one of (((1))) to (((3))), comprising: the rubber.
(((5))) The composition according to (((3))),
wherein the number-average particle size of the fillers is 15 μm or more and 40 μm or less.
(((6))) The composition according to any one of (((1))) to ((5))),
wherein the composition has a thermal conductivity of 1.2 W/mK or more.
(((7))) The composition according to any one of (((1))) to (((6))),
wherein a content of the fillers is 5% by volume or more and 50% by volume or less with respect to the composition.
(((8))) The composition according to (((7))),
wherein the content of the fillers is 5% by volume or more and 20% by volume or less with respect to the composition.
(((9))) The composition according to any one of (((1))) to (((8))),
wherein an aspect ratio of the fillers is 6 or less.
(((10))) A molded article comprising:
the composition according to any one of the (((1))) to (((9))).
(((11))) A fixing member comprising:
a substrate layer; and
an elastic layer provided on the substrate layer,
wherein at least one of the substrate layer or the elastic layer contains the composition according to any one of (((1))) to (((9)))
(((12))) A fixing device comprising:
a first rotary member; and
a second rotary member that is arranged in contact with an outer surface of the first rotary member,
wherein at least one of the first rotary member or the second rotary member is the fixing member according to (((11))).
(((13))) An image forming apparatus comprising:
an image holder;
a charging device that charges a surface of the image holder;
an electrostatic latent image forming device that forms an electrostatic latent image on the charged surface of the image holder;
a developing device that develops the electrostatic latent image formed on the surface of the image holder with a toner to form a toner image;
a transfer device that transfers the toner image formed on the surface of the image holder to a recording medium; and
the fixing device according to (((12))) that fixes the toner image to the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A composition comprising:
at least one or more thermal conductive fillers; and
a resin or rubber,
wherein the fillers have a shape factor SF1 of 120 or more and 400 or less and a shape factor SF2 of 140 or more and 325 or less.

2. The composition according to claim 1, comprising:
the resin.

3. The composition according to claim 1,
wherein a number-average particle size of the fillers is 0.5 μm or more and 10 μm or less.

4. The composition according to claim 1, comprising:
the rubber.

5. The composition according to claim 3,
wherein the number-average particle size of the fillers is 15 μm or more and 40 μm or less.

6. The composition according to claim 1,
wherein the composition has a thermal conductivity of 1.2 W/mK or more.

7. The composition according to claim 1,
wherein a content of the fillers is 5% by volume or more and 50% by volume or less with respect to the composition.

8. The composition according to claim 7,
wherein the content of the fillers is 5% by volume or more and 20% by volume or less with respect to the composition.

9. The composition according to claim 1,
wherein an aspect ratio of the fillers is 6 or less.

10. A molded article comprising:
the composition according to claim 1.

11. A molded article comprising:
the composition according to claim 2.

12. A molded article comprising:
the composition according to claim 3.

13. A molded article comprising:
the composition according to claim 4.

14. A molded article comprising:
the composition according to claim 5.

15. A molded article comprising:
the composition according to claim 6.

16. A molded article comprising:
the composition according to claim 7.

17. A molded article comprising:
the composition according to claim 8.

18. A fixing member comprising:
a substrate layer; and
an elastic layer provided on the substrate layer,
wherein at least one of the substrate layer or the elastic layer contains the composition according to claim 1.

19. A fixing device comprising:
a first rotary member; and
a second rotary member that is arranged in contact with an outer surface of the first rotary member,
wherein at least one of the first rotary member or the second rotary member is the fixing member according to claim 18.

20. An image forming apparatus comprising:
an image holder;
a charging device that charges a surface of the image holder;
an electrostatic latent image forming device that forms an electrostatic latent image on the charged surface of the image holder;
a developing device that develops the electrostatic latent image formed on the surface of the image holder with a toner to form a toner image;
a transfer device that transfers the toner image formed on the surface of the image holder to a recording medium; and
the fixing device according to claim 19 that fixes the toner image to the recording medium.
